(19) United States
(12) Patent Application Publication
(10) Pub. No.: US 2017/0277303 A1
(43) Pub. Date: Sep. 28, 2017

(54) Electrical Property Detection Device and Method for Touch Electrode

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventors: Qingyou CHEN, Beijing (CN); Ji LI, Beijing (CN); Jun CHEN, Beijing (CN); Cheng ZHANG, Beijing (CN)

(21) Appl. No.: 15/504,095

(22) PCT Filed: Jan. 5, 2016
(86) PCT No.: PCT/CN2016/070103

§ 371 Date: Feb. 15, 2017

(30) Foreign Application Priority Data
Aug. 31, 2015 (CN) 201510549213.4

(51) Int. Cl. G06F 3/044

(52) U.S. Cl. CPC G06F 3/044; G06F 2203/04103; G06F 2203/04112; G06F 2203/04104

(57) ABSTRACT

The present invention discloses an electrical property detection device and method for a touch electrode. The electrical property detection device includes a capacitor formation unit configured to form a capacitor structure with the touch electrode to be detected; and a capacitance detection unit configured to obtain a capacitance value of the capacitor structure. In the technical solutions of the present invention, the capacitor structure is formed by the capacitor formation unit and the touch electrode to be detected, and then the capacitance value of the capacitor structure is obtained by the capacitance detection unit, so that a detector can effectively and accurately evaluate the electrical property of the touch electrode based on the obtained capacitance value of the capacitor structure.

### TECHNICAL HELD

The present invention relates to the field of display technology, and particularly relates to an electrical property detection device and an electrical property detection method for a touch electrode.

### BACKGROUND

Recently, capacitive touch screens gain high popularity due to their high transmittance, abrasion resistance, resistance to environmental temperature changes, resistance to environmental humidity changes, long life, and capability of achieving advanced complex functions such as multi-touch.

At present, capacitive touch screens are categorized into mutual capacitive touch screens and self-capacitive touch screens. In a mutual capacitive touch screen, two mutual capacitive electrode layers opposite to each other are provided. When the mutual capacitive touch screen is not touched by a finger, a mutual capacitance having a fixed value is generated between corresponding mutual capacitive electrodes in the two mutual capacitive electrode layers. When the mutual capacitive touch screen is touched by a finger, the mutual capacitance between the corresponding mutual capacitive electrodes will be changed, and thus, a touch detection chip can detect a point position Where the finger touches by detecting a difference between the mutual capacitances before and after the finger touches the screen. In a self-capacitive touch screen, only one self-capacitive electrode layer is provided. When the self-capacitive touch screen is not touched by a finger, capacitances of respective self-capacitive electrodes in the self-capacitive electrode layer have a fixed value. When the self-capacitive touch screen is touched by a finger, capacitances of the respective self-capacitive electrodes become the sum of the fixed value and body capacitance, and thus, a touch detection chip can detect a touch position by detecting a change in capacitance values of the self-capacitive electrodes.

In order to ensure touch performance of a touch screen, it is necessary to detect electrical properties of the mutual capacitive electrodes in the mutual capacitive electrode layers or the self-capacitive electrodes in the self-capacitive electrode layer, which are used for achieving touch-control function, in the touch screen, so as to evaluate the touch performance of the touch screen.

In detection of electrical properties of the mutual capacitive electrodes in the mutual capacitive touch screen, a pair of mutual capacitive electrodes for generating a mutual capacitance may be directly selected, a value of capacitance between the pair of mutual capacitive electrodes is detected by a capacitance detection device (e.g., multimeter), and the electrical property of the pair of the mutual capacitive electrodes is evaluated according to the detected value of capacitance. However, in detection of electrical properties of the self-capacitive electrodes in the self-capacitive touch screen, each self-capacitive electrode cannot constitute a capacitor structure together with another self-capacitive electrode because all of the self-capacitive electrodes are arranged in a same layer, and thus, electrical properties of the self-capacitive electrodes cannot be evaluated by way of capacitance measurement. In view of this problem, electrical properties of the self-capacitive electrodes are generally evaluated by measuring resistances of the self-capacitive electrodes in the prior art.

However, because the resistances of the self-capacitive electrodes are likely to be changed as being susceptible to the external environment, which results in inaccurate measurement result, it is not reliable to evaluate the electrical properties of the self-capacitive electrodes based on the resistances of the self-capacitive electrodes.

Therefore, how to detect electrical properties of the self-capacitive electrodes more accurately and effectively is an urgent technical problem to be solved by those skilled in the art.

### SUMMARY

The present invention provides an electrical property detection device and method of a touch electrode, which can effectively achieve accurate detection of electrical property of a self-capacitive touch electrode.

The electrical property detection device for a touch electrode provided in the present invention includes:

a capacitor formation unit configured to form a capacitor structure with the touch electrode; and

a capacitance detection unit configured to obtain a capacitance value of the capacitor structure.

Optionally, the capacitor formation unit comprises:

a conductive electrode and an insulating dielectric layer formed on a surface of the conductive electrode, and

the capacitance detection unit is configured to be electrically connected to the conductive electrode.

Optionally, the insulating dielectric layer is made of a material having low dielectric constant.

Optionally, the conductive electrode is made of a metal material.

Optionally, the capacitor formation unit further includes a protection layer provided on a surface of the insulating dielectric layer.

Optionally, the protection layer is made of a flexible material.

Optionally, the conductive electrode has the same shape and size as the touch electrode.

Optionally, a metal wire is provided on the touch electrode, and the capacitance detection unit is configured to be electrically connected to the touch electrode via the metal wire.

Optionally, the electrical property detection device for a touch electrode further includes:

a drive unit, which is connected to the capacitor formation unit and configured to drive the capacitor formation unit to move.

Optionally, the drive unit is detachably connected to the capacitor formation unit.

In order to achieve the above object, the present invention further provides an electrical property detection method for a touch electrode, which uses the above electrical property detection device for a touch electrode to perform steps of:

moving the capacitor formation unit to a position exactly opposite to the touch electrode and contacting the capacitor formation unit with the touch electrode, so that the capacitor formation unit and the touch electrode form a capacitor structure; and

obtaining, by the capacitance detection unit, a capacitance value of the capacitor structure.

The present invention provides an electrical property detection device and method of a touch electrode, and the electrical property detection device includes a capacitor formation unit configured to form a capacitor structure together with the touch electrode to be detected and a capacitance detection unit configured to obtain a capacitance value of the formed capacitor structure. In the technical solutions of the present invention, the capacitor structure is formed by the capacitor formation unit and the touch electrode to be detected, and then the capacitance value of the capacitor structure is obtained by the capacitance detection unit, so that a detector can effectively and accurately evaluate the electrical property of the touch electrode based on the obtained capacitance value of the capacitor structure.

### BRIEF DESCRIPTION OF THE FIGURES

FIG. 1 is a schematic structure diagram of an electrical property detection device for a touch electrode provided in an embodiment of the present invention.

FIG. 2 is a schematic diagram of detecting a touch electrode using the electrical property detection device shown in FIG. 1.

FIG. 3 is a flowchart of an electrical property detection method for a touch electrode provided in an embodiment of the present invention.

### DETAILED DESCRIPTION

To enable those skilled in the art to better understand the technical solutions of the present invention, an electrical property detection device and an electrical property detection method for a touch electrode provided in the present invention will be described in detail below in conjunction with the accompanying drawings.

It should be noted that, the touch electrode in the embodiments of the present invention specifically refers to a self-capacitive touch electrode in a self-capacitive touch screen.

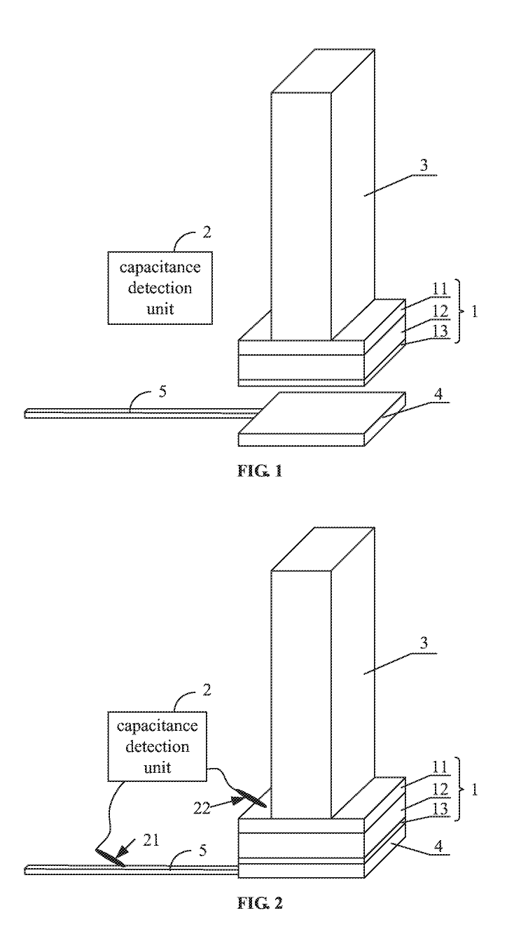

FIG. 1 is a schematic structure diagram of an electrical property detection device for a touch electrode provided in an embodiment of the present invention, and FIG. 2 is a schematic diagram of detecting a touch electrode using the electrical property detection device shown in FIG. 1. As shown in FIGS. 1 and 2, the electrical property detection device includes: a capacitor formation unit 1 configured to form a capacitor structure with a touch electrode 4 and a capacitance detection unit 2 configured to obtain a capacitance value of the formed capacitor structure. The capacitance detection unit 2 has two detection terminals 21 and 22. One detection terminal 21. is electrically connected to the touch electrode 4, and the other detection terminal 22 is electrically connected to the capacitor formation unit 1, thus obtaining the capacitance value of the formed capacitor structure.

It should be noted that, the capacitance detection unit 2 in the embodiment may be a multimeter.

In the embodiment, a capacitor structure is formed by the capacitor formation unit 1 and the touch electrode 4 to be detected, and the capacitance detection unit 2 obtains the capacitance value of the formed capacitor structure. In this case, a detector evaluates the electrical property of the touch electrode 4 to be detected based on the obtained capacitance value of the capacitor structure (electrical properties of components in the capacitor formation unit 1 may be obtained in advance).

Optionally, the capacitor formation unit 1 includes a conductive electrode 11 and an insulating dielectric layer 12 formed on a surface of the conductive electrode 11 (under the conductive electrode 11 in the figures), and the detection terminal 22 of the capacitance detection unit 2 is electrically connected to the conductive electrode 11. When the electrical property of the touch electrode 4 to be detected is detected, it only needs to contact the insulating dielectric layer 12 with the touch electrode 4 to be detected, and in this case, the conductive electrode 11 and the touch electrode 4 to be detected may form a capacitor structure.

In the process of forming the capacitor structure by using the capacitor formation unit 1 and the touch electrode 4 to be detected, since the touch electrode 4 to be detected is generally made of a soft conductive material such as ITO or the like, the surface of the touch electrode 4 may be scratched when the insulating dielectric layer 12 contacts with the touch electrode 4 to be detected, thus causing defect of the touch electrode 4. In order to solve this technical problem, in the embodiment, a protection layer 13 may be provided on the surface of the insulating dielectric layer 12 (under the insulating dielectric layer 12 in the figures) and configured to prevent the insulating dielectric layer 12 from damaging the surface of the touch electrode 4 to be detected. Optionally, the protection layer 13 is made of a flexible material. Optionally, the protection layer 13 may cover the entire surface of the insulating dielectric layer 12.

It should be noted that, in the case where the capacitor formation unit 1 includes the protection layer 13, the protection layer 13 contacts with the touch electrode 4 to be detected when the electrical property of the touch electrode 4 is detected.

In the embodiment, in order to detect the electrical property of the entire touch electrode 4, shape and size of the conductive electrode 11 may be set to be exactly the same as those of the touch electrode 4 to be detected, and in this case, the conductive electrode 11 may be exactly aligned with the touch electrode 4 to be detected. Needless to say, the above insulating dielectric layer 12 and the protection layer 13 may be set to have exactly the same shape and size as the conductive layer 11.

Optionally, the insulating dielectric layer 12 may be made of a material with low dielectric constant, such as carbon doped silicon oxide film, fluorine doped silicon oxide film, porous silicon film, polyimide, polytetrafluoroethylene, epoxy cyanate ester, nano glass, or the like. Because the material with low dielectric constant has characteristics such as low loss, low leakage current, high adhesion, corrosion resistance, low shrinkage, and the like, using the material with low dielectric constant to form the insulating dielectric layer 12 in the embodiment can effectively reduce a parasitic capacitance between the conductive layer 11 and the touch electrode 4 to be detected, ensure accurate detection of the capacitance between the conductive electrode 11 and the touch electrode 4 in a subsequent process, and effectively lower the overall power consumption of the device.

In addition, in the process of obtaining the capacitance value of the formed capacitor structure by using the capacitance detection unit 2, in order to ensure a small touch resistance between the detection terminals 21 and 22 of the capacitance detection unit 2 and the formed capacitor structure, tops of the two detection terminals 21 and 22 are generally configured to be thin. However, when the detection terminals 21 and 22 having thin tops contact the conductive electrode 11 and the touch electrode 4 to be detected in the formed capacitor structure, it is likely to damage the surfaces of the conductive electrode 11 and the touch electrode 4.

In order to prevent the detection terminal 22 from damaging the surface of the conductive electrode 11, the conductive electrode 11 is made of a metal material in the embodiment, which can ensure both conductivity and hardness of the conductive electrode 11, thus prevent the surface of the conductive electrode 11 from being damaged by the detection terminal 22 effectively, and further prolong the service life of the conductive electrode 11.

In order to prevent the detection terminal 21 from damaging the surface of the touch electrode 4 to be detected, in the embodiment, the detection terminal 21 of the capacitance detection unit 2 is not directly connected to the touch electrode 4 to be detected, but connected to a metal wire 5 (for transferring signals between the touch electrode 4 and the chip) provided on the touch electrode 4 to be detected, and the capacitance detection unit 2 is electrically connected to the touch electrode 4 to be detected via the metal wire 5.

Optionally, the electrical property detection device further includes: a drive unit 3 which is connected to the capacitor formation unit 1 and used for driving the capacitor formation unit 1 to move. In the embodiment, the setting of the drive unit 3 can effectively increase the degree of automation of the device. More importantly, under the control of the drive unit 3, alignment between the capacitor formation unit 1 and the touch electrode 4 to be detected may be more accurate, and in this way, evaluation of the electrical property of the touch electrode 4 is more accurate.

It needs to be additionally set forth that, in the electrical property detection device provided in the embodiment, various capacitor formation units 1 of different shapes and sizes may be configured. In this way, the electrical property detection device can detect electrical properties of touch electrodes 4 of different shapes and sizes. Preferably, the drive unit 3 may be detachably connected to the capacitor formation unit 1, which facilitates replacement of the capacitor formation unit 1.

Embodiments of the present, invention provide an electrical property detection device of a touch electrode, which includes a capacitor formation unit configured to form a capacitor structure together with the touch electrode to be detected and a capacitance detection unit configured to obtain capacitance value of the formed capacitor structure. In the technical solution of the present invention, the capacitor formation unit and the touch electrode to be detected form the capacitor structure, and then the capacitance value of the capacitor structure is obtained by using the capacitance detection unit, so that a detector can effectively and accurately evaluate the electrical property of the touch electrode based on the obtained capacitance value of the capacitor structure.

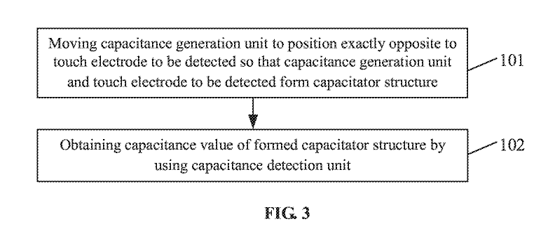

FIG. 3 is a flowchart of an electrical property detection method for a touch electrode provided in an embodiment of the present invention. As shown in FIG. 3, the electrical property detection method is implemented by using the electrical property detection device in the above embodiments, and includes the following steps.

At step 101, the capacitor formation unit is moved to a position exactly opposite to the touch electrode to be detected and contacts the touch electrode to be detected, so that the capacitor formation unit and the touch electrode to be detected form a capacitor structure.

In step 101, the capacitor formation unit may be moved to a position exactly opposite to the touch electrode to be detected by the drive unit in the above embodiment and contacts the touch electrode to be detected, so that the capacitor formation unit and the touch electrode to be detected form a capacitor structure.

It should be noted that, it is a preferable solution of the embodiment to move the capacitor formation unit to the position right opposite to the touch electrode to be detected by the drive unit, it is also possible to manually move the capacitor formation unit to be aligned with and contact the touch electrode to be detected by a detector in the embodiment.

At step 102, capacitance value of the formed capacitor structure is obtained by using the capacitance detection unit.

In step 102, the capacitance detection unit is used to obtain the capacitance value of the capacitor structure formed by the capacitor formation unit and the touch electrode to be detected. In the case where electrical properties of components in the capacitor formation unit can be obtained in advance, the detector can evaluate the electrical property of the touch electrode to be detected based on the capacitance value detected by the capacitance detection unit.

Embodiments of the present invention provide an electrical property detection method of a touch electrode, including steps of moving the capacitor formation unit to a position exactly opposite to the touch electrode to be detected and contacting the capacitor formation unit with the touch electrode to be detected, so that the capacitor formation unit and the touch electrode to be detected form a capacitor structure; and using the capacitance detection unit to obtain the capacitance value of the formed capacitor structure. In the technical solution of the present invention, the capacitor structure is formed by the capacitor formation unit and the touch electrode to be detected, and then the capacitance value of the formed capacitor structure is obtained by using the capacitance detection unit, so that the detector can effectively and accurately evaluate the electrical property of the touch electrode based on the obtained capacitance value of the capacitor structure.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are also deemed as falling within the protection scope of the present invention.

1. An electrical property detection device for a touch electrode, comprising:
a capacitor formation unit configured to form a capacitor structure with the touch electrode; and
a capacitance detection unit configured to obtain a capacitance value of the capacitor structure.

2. The electrical property detection device for a touch electrode according to claim 1, wherein, the capacitor formation unit comprises:
a conductive electrode and an insulating dielectric layer formed on a surface of the conductive electrode, and
the capacitance detection unit is configured to be electrically connected to the conductive electrode.

3. The electrical property detection device for a touch electrode according to claim 2, wherein, the insulating dielectric layer is made of a material having low dielectric constant.

4. The electrical property detection device for a touch electrode according to claim 2, wherein, the conductive electrode is made of a metal material.

5. The electrical property detection device for a touch electrode according to claim 2, wherein, the capacitor formation unit further comprises a protection layer provided on a surface of the insulating dielectric layer.

6. The electrical property detection device for a touch electrode according to claim 5, wherein, the protection layer is made of a flexible material.

7. The electrical property detection device for a touch electrode according to claim 2, wherein, the conductive electrode has the same shape and size as the touch electrode.

8. The electrical property detection device for a touch electrode according to claim 1, wherein, a metal wire is provided on the touch electrode, and the capacitance detection unit is electrically connected to the touch electrode via the metal wire.

9. The electrical property detection device for a touch electrode according to claim 1, further comprising:
a drive unit, which is connected to the capacitor formation unit and configured to drive the capacitor formation unit to move.

10. The electrical property detection device for a touch electrode according to claim 9, wherein, the drive unit is detachably connected to the capacitor formation unit.

11. An electrical property detection method for a touch electrode, using the electrical property detection device for a touch electrode according to claim 1 to perform steps of:
moving the capacitor formation unit to a position exactly opposite to the touch electrode and contacting the capacitor formation unit with the touch electrode, so that the capacitor formation unit and the touch electrode form a capacitor structure; and
obtaining, by using the capacitance detection unit, a capacitance value of the capacitor structure.

12. The electrical property detection method for a touch electrode according to claim 11, wherein, the capacitor formation unit is moved to the position exactly opposite to the touch electrode and contacted with the touch electrode by a drive unit.

13. The electrical property detection method for a touch electrode according to claim 11, wherein, the capacitor formation unit comprises:
a conductive electrode and an insulating dielectric layer formed on a surface of the conductive electrode, and
the capacitance detection unit is configured to be electrically connected to the conductive electrode.

14. The electrical property detection method for a touch electrode according to claim 13, wherein, the insulating dielectric layer is made of a material having low dielectric constant.

15. The electrical property detection method for a touch electrode according to claim 13, wherein, the conductive electrode is made of a metal material.

16. The electrical property detection method for a touch electrode according to claim 13, wherein, the capacitor formation unit further comprises a protection layer provided on a surface of the insulating dielectric layer.

17. The electrical property detection method for a touch electrode according to claim 16, wherein, the protection layer is made of a flexible material.

18. The electrical property detection method for a touch electrode according to claim 13, wherein, the conductive electrode has the same shape and size as the touch electrode.
